(19) United States
(12) Patent Application Publication
(10) Pub. No.: US 2012/0168276 A1
(43) Pub. Date: Jul. 5, 2012

(54) APPARATUS FOR COUPLING TORQUE

(76) Inventors: CONNARD CALI, Danville, CA (US); CARLOS FERREIRA, Brusque (BR)

(21) Appl. No.: 13/343,257

(22) Filed: Jan. 4, 2012

Related U.S. Application Data
(60) Provisional application No. 61/429,670, filed on Jan. 4, 2011.

(51) Int. Cl. F16D 43/02

(52) U.S. Cl. 192/41 R

(57) ABSTRACT

Apparatus for coupling torque are provided herein. In some embodiments, an apparatus for coupling torque may include a shaft; a pulley body disposed about the shaft, the pulley body and shaft rotatable with respect to each other; a one-way clutch bearing disposed between the pulley body and shaft; and a journal bearing disposed proximate a first end of the one-way clutch bearing, wherein at least one of the pulley body and the shaft form a race of at least one of the one-way clutch bearing or journal bearing.

### CROSS-REFERENCE TO RELATED APPLICATIONS

This application claims benefit of U.S. provisional patent application Ser. No. 61/429,670, filed Jan. 4, 2011, which is herein incorporated by reference.

### FIELD

Embodiments of the present invention generally relate to torque load transfer devices.

### BACKGROUND

Belt driven Front Engine Accessory Drive (FEAD) systems must cope with dynamically conflicting trends in engine and vehicle design. These trends increase Noise Vibration and Harshness (NVH) and reduce the life of FEAD components, such as belts, tensioners, bearings, to name a few.

The trends in engine and vehicle design may include, but are not limited to:

1. Increased vehicle electrical demands to support ever increasing vehicle convenience accessories and the electrification of power steering and other belt-path engine components. Higher output alternators, and thus, larger rotors, are required. The alternator presents the highest rotational inertia (i.e., resistance to speed changes) to the fluctuations in engine speed change naturally inherent to the combustion and compression events. Increased rotors and induced magnetic fields from these larger alternators cause greater fluctuations in the tension of the belt as well as larger amplitude compensating torsionals from the FEAD tensioner.

2. Higher output alternators must provide the largest percentage possible of their maximum rated output albeit driven only by low rpm engine idle conditions.

3. Fuel-efficient engines utilize direct injection, high compression, and low engine idle speeds, which result in large fluctuations of engine torque. These fluctuations not only increase system NVH, but also impose high stresses on downstream FEAD components to the crankshaft.

4. Reduced vehicle weight and downsized engine peripherals, which require downsizing and slimming of engine auxiliaries.

5. For diesel engines characterized by large torque fluctuations, FEAD component high torque capacity is needed. For gasoline engines that operate at high rotational speeds, responsiveness at high-speed rotation is required.

6. Continually increasing competitive pressure for cost reductions while incongruously requiring increased durability.

The inventors have observed that conventional active pulley designs typically consist of a pulley body having a shaft coupled to stand alone bearings, for example, such as one-way bearings (e.g., roller or sprag clutch) or two-way bearings (e.g., ball or roller bearings). Invariably, these designs are self-limiting as they require heavy and expensive machinery to manufacture and/or machine the pulley bodies.

Therefore, the inventors have provided improved overrunning pulley designs that are more durable, lower cost, require fewer components, simplify assembly, lower weight, lower rotational inertia, reduce pulley diameters for higher output at engine idle, can carry higher torque loads, offer improvement in high-speed idling performance, and/or simplify the manufacturing of key components via straighter shaft outer diameter (OD) and/or body inner diameter (ID).

### SUMMARY

Apparatus for coupling torque is provided herein. In some embodiments, an apparatus for coupling torque may include a shaft; a pulley body disposed about the shaft, the pulley body and shaft rotatable with respect to each other; a one-way clutch bearing disposed between the pulley body and shaft; and a journal bearing disposed proximate a first end of the one-way clutch bearing, wherein at least one of the pulley body and the shaft form a race of at least one of the one-way clutch bearing or journal bearing.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIGS. 1-15 depict various views of an apparatus for coupling torque in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention provide improved apparatus for coupling torque (i.e., overrunning pulleys) that overcome one or more of the deficiencies in the background noted above. Such pulley designs may be used in such non-limiting applications as industrial conveyor systems, superchargers, starting and/or charging (alternators & hybrid) systems in engines and motors, or the like that exhibit significant rotational inertia. The inventive apparatus advantageously provides an active pulley design requiring fewer components than currently available pulley designs, thus making it more durable, easier and less expensive to manufacture, and lower in weight, as compared to conventional active pulley designs.

In any of the embodiments described below, the overrunning pulley components may be manufactured from any suitable metal (e.g., such as aluminum, steel, iron, or the like) via any suitable process (e.g., such as sintering, metal injection molding (MIM), extrusion, casting, or the like) or polymers (e.g., thermoplastics, thermosets, or the like) via any suitable process (e.g., extrusion, casting, cost and/or injection molding, or the like). This would include, but not be limited to, phenolics and urethanes. The springs in any of the embodiments below may be resilient members of any elastic or viscoelastic nature, as well as metallic. In embodiments where metallic portions of the overrunning pulleys interface with polymer portions, the polymers could be overmolded or glued in place.

In addition, in any of the embodiments described below, any two-way and one-way bearings in each embodiment can be shielded or sealed, thus allowing them to be self-lubricating and sealed. However, the possibility of open bearings is also an option in these designs, requiring only the sealing of lubricants at another location in the assembly.

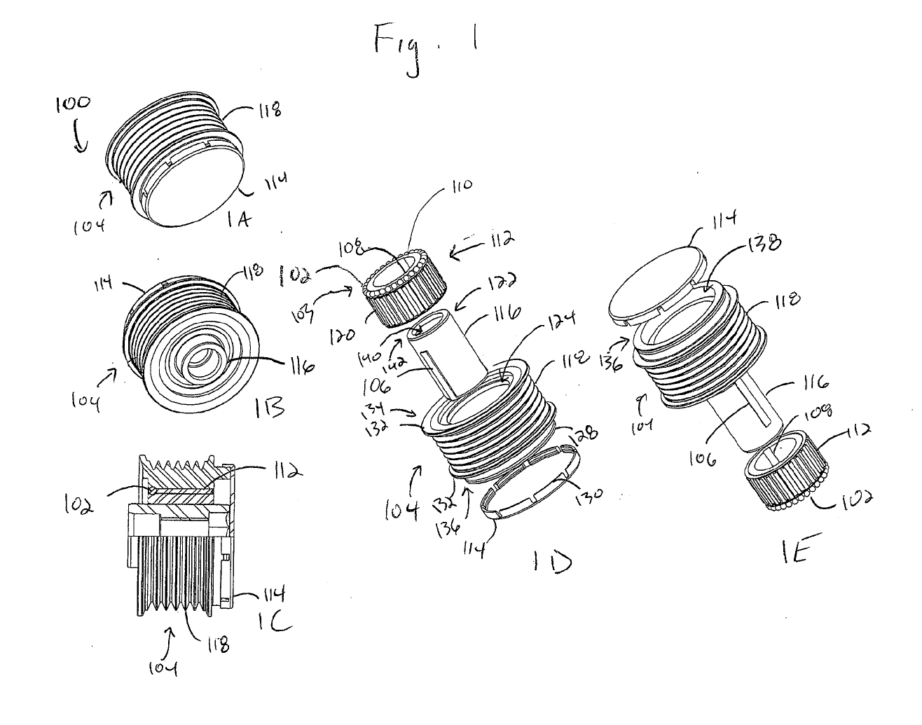

FIG. 1 depicts various views (FIGS. 1A-E) of an overrunning pulley 100 in accordance with some embodiments of the present invention. Specifically, FIGS. 1A-B are perspective views of the pulley 100 from opposing sides of the pulley 100. FIG. 1C is a cross-sectional view perpendicular to the axis of rotation of the pulley 100. FIGS. 1D-E are exploded perspective views of the pulley 100 from opposing sides of the pulley 100.

The overrunning pulley 100 generally comprises a pulley body 104 housing a one or more journal bearings (one journal bearing 102 shown in FIGS. 1D-E), a one-way clutch bearing 112 and a shaft 116. The components housed within the pulley body 104 may be secured in place within the pulley body 104 via any suitable mechanism, for example such as being press fit, keyed, slotted, overmolded, glued, threaded, crimped, ring-locked, or other suitable methods.

In some embodiments, the pulley body 104 is hollow, having a tubular shape with an outer drive surface 118 for interfacing with a driven element, for example via a v-groove belt (although other suitable driving mechanisms may be used). A flange 132 may be disposed proximate each of the first end 134 and second end 136 of the pulley body 104 to prevent slippage of the drive mechanism from the outer drive surface 118. The outer drive surface 118 may be machined into the pulley body 104, and/or molded as part of the pulley body 104. The pulley body 104 may be manufactured from any suitable material via any suitable technique, for example such as the materials and techniques described above.

The shaft 116 fits within the one-way clutch bearing 112. In some embodiments, the shaft 116 may be hollow and comprise one or more features (e.g., threads, hex interface, or the like) in the inner portion 140 proximate the first end 142 to facilitate coupling the shaft 116 to a drive shaft or motor shaft (not shown).

The one-way clutch bearing 112 may be any type of one-way clutch bearing, for example, a one-way overrunning clutch such as a sprag clutch 120, as shown in FIG. 1. In some embodiments, the one-way clutch bearing 112 may comprise an inner race 110 having a notch 108 configured to interface with a key 106 of the shaft 116 to facilitating simultaneous rotation of the shaft and inner race 110. The journal bearing 102 is disposed proximate a first end 103 of the one-way clutch bearing 112 and facilitates consistent alignment of the shaft 116 with respect to the pulley body 104.

In some embodiments, for example as shown in FIG. 1, the inner diameter 124 of the pulley body 104 forms an outer race of the one-way clutch bearing 112, therefore eliminating the need for a separate outer race to be included in the overrunning pulley 100, therefore providing an active pulley design requiring fewer components, thus making it more durable, easier to manufacture (e.g., simplicity in fabricating components such as the shaft 116 outer diameter 122, the pulley body 104 inner diameter 124, or the like), less expensive to manufacture, and lower in weight, as compared to conventional active pulley designs.

In some embodiments, the shaft 116 may be coupled to a motor shaft (not shown) of an engine. Access to the shaft 116 during installation may be provided via an opening 138 in the second end 136. Following the coupling of the motor shaft to the shaft 116, a cap 114 may be secured to the second end 136 of the pulley body 104. The cap 114 prevents objects and/or substances, such as debris, oil, moisture, or the like from entering the pulley body 104. The cap 114 may be secured to the second end 136 of the pulley body 104 via a plurality of tabs 130 configured to interface with an outwardly extending ridge 128 of the pulley body 104.

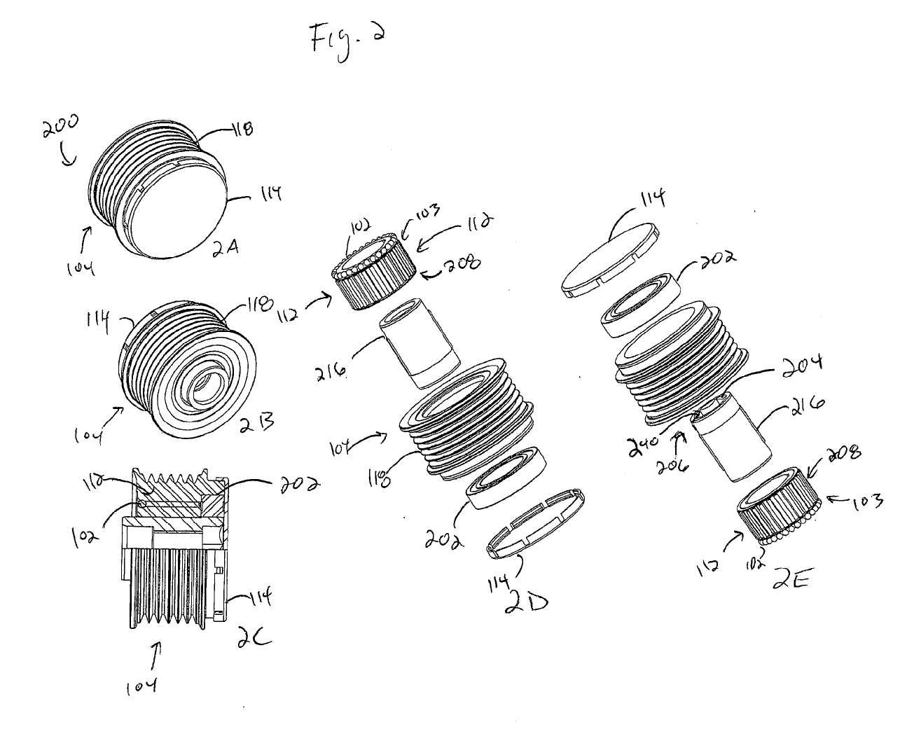

As depicted in FIG. 2E, in some embodiments, the shaft 216 of the overrunning pulley 200 may further comprise one or more features, for example, such as a hex socket 204 formed in the inner portion 240 proximate the second end 206 of the shaft 216. When present, the one or more features are configured to receive a tool to facilitate installation of the shaft 216 to the motor shaft.

In some embodiments, an additional bearing 202, for example such as a roller bearing may be disposed proximate a second end 208 of the one-way clutch bearing 112, opposite the first end 103, for example such as depicted in FIGS. 2C-E. The additional bearing 202 may provide support to the shaft 216 and facilitate a consistent alignment of the shaft 216 with respect to the pulley body 104 in the event that a lateral force exerted by the drive mechanism on the outer drive surface 118 of the pulley body 104 causes a bending moment.

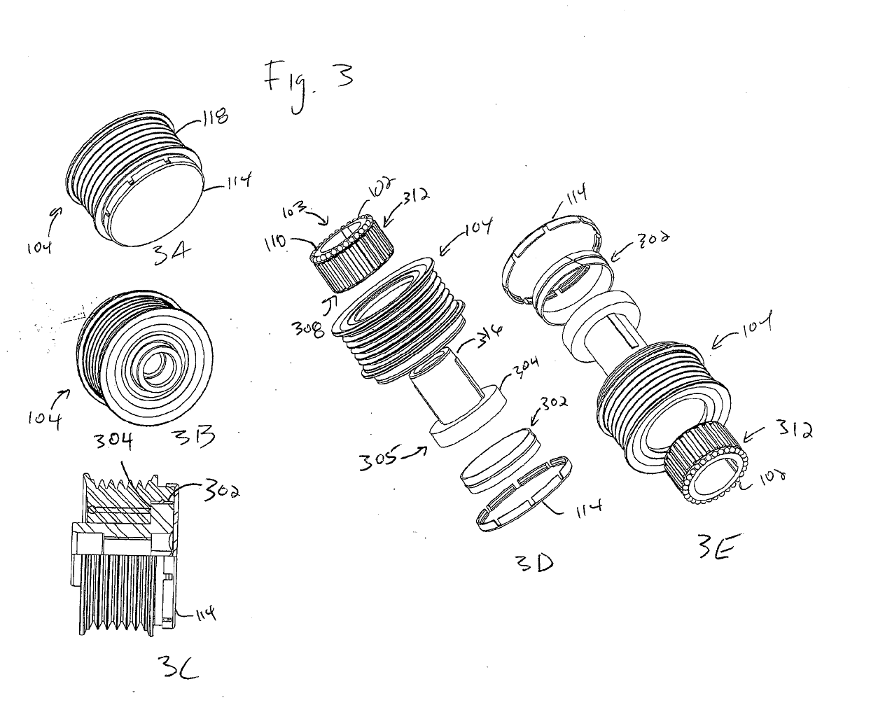

As depicted in FIGS. 3C-E, alternatively, or in combination, in some embodiments, a bushing 302 may be disposed proximate a second end 308 of the one-way clutch bearing 312, opposite the first end 103. In such embodiments, the shaft 316 may comprise a flange 304 proximate the second end 305 of the shaft 316 configured to accommodate the bushing 302. In some embodiments, the shaft 316 and flange 304 may be fabricated in two separate parts and coupled together via welding, brazing, or the like. Alternatively, in some embodiments, the flange 304 and the shaft 316 may be fabricated from a single piece of material.

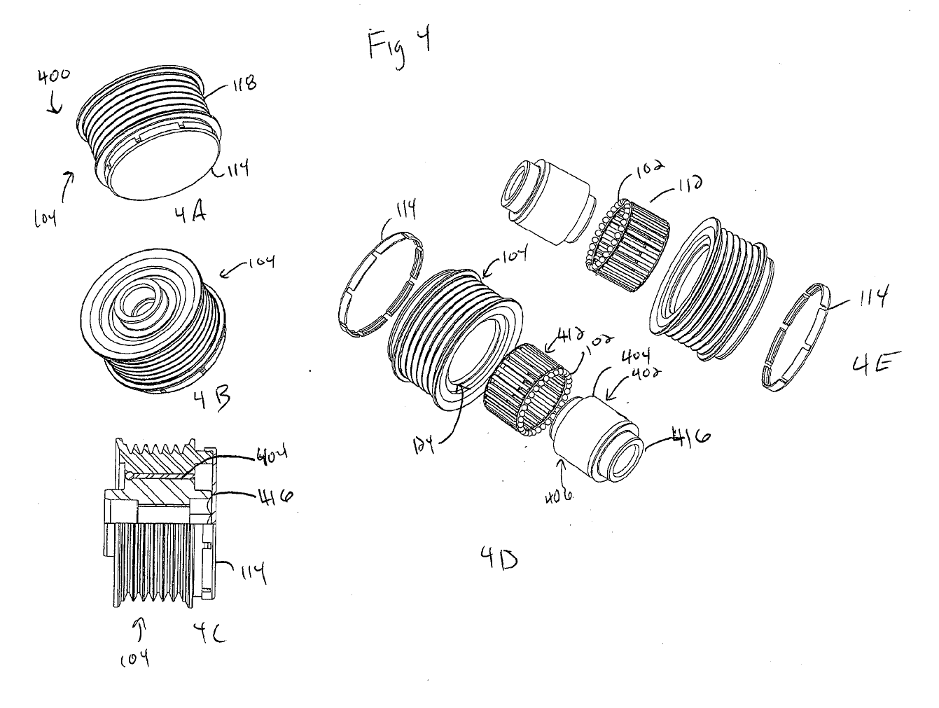

As depicted in FIGS. 4C-E (also shown in 5C-E-13C-E, described below), in some embodiments, to eliminate the need for a separate inner race (e.g., inner race 110 described above) of the one-way clutch bearing 412, the shaft 416 may function at the inner race. In such embodiments, the shaft 416 may comprise a portion 404 having an increased outer diameter 406 proximate the center 402 of the shaft 416, for example, as depicted in FIGS. 4C-E. In such embodiments, the inner diameter 124 of the pulley body 104 forms the outer race of the one-way clutch bearing 412 and the outer diameter 406 of the central portion 404 of the shaft 416 forms the inner race of the one-way clutch bearing 412, thereby providing an overrunning pulley 400 having less parts, thus making it easier and less expensive to manufacture.

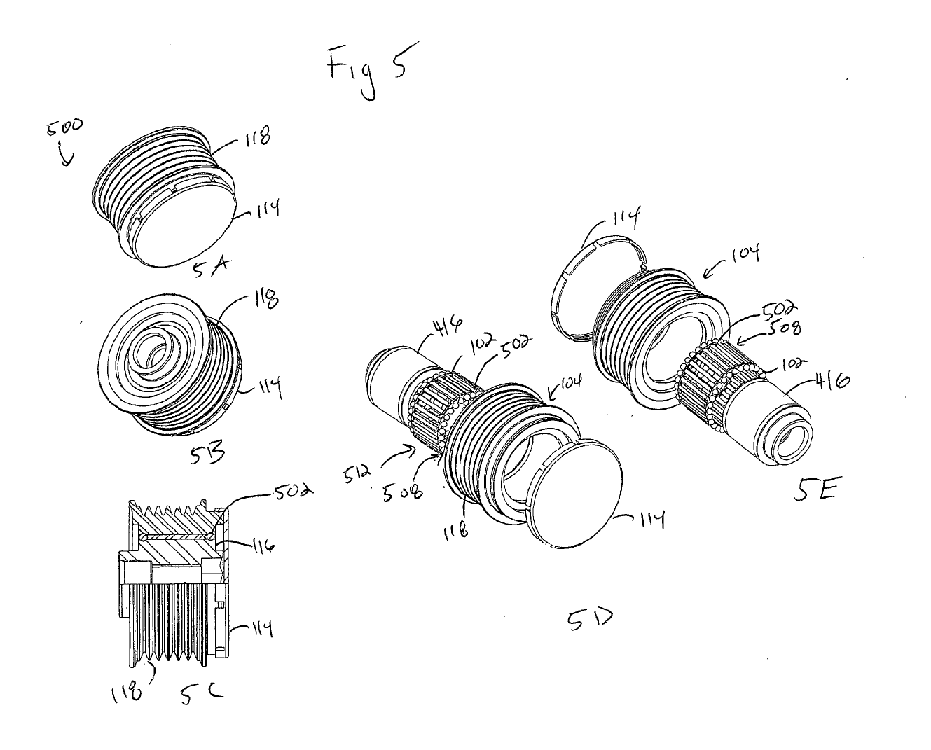

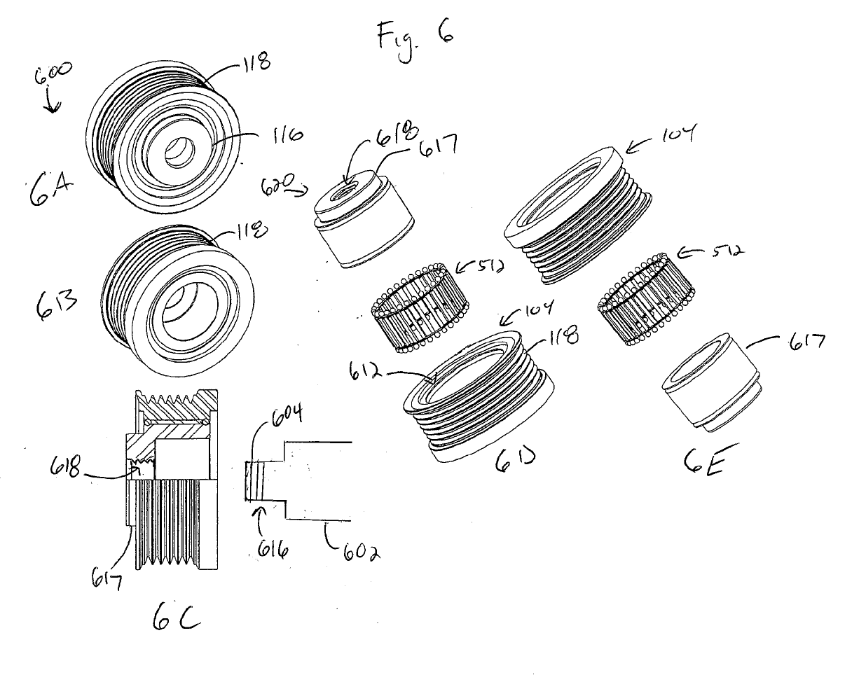

As depicted in FIGS. 5C-E (also shown in FIGS. 6C-E-13C-E, described below), in some embodiments, the one-way clutch bearing 512 may comprise a second journal bearing 502 disposed proximate the second end 508 of the one-way clutch bearing 512. In such embodiments, the second journal bearing 502 may provide additional support to the shaft 416 and further facilitate consistent alignment of the shaft 416 with respect to the pulley body 104.

FIG. 6 depicts an overrunning pulley 600 having a similar design to the overrunning pulley 500 of FIG. 5. However, the overrunning pulley 600 of FIG. 6 provides an opening 612 having a diameter configured to accommodate a wider rotor shaft 602, such as shown in FIGS. 6C-E. In such embodiments, the rotor shaft 602 may comprise an outwardly extending portion 616 having threads 604 configured to interface with an inner threaded portion 618 of the shaft 617.

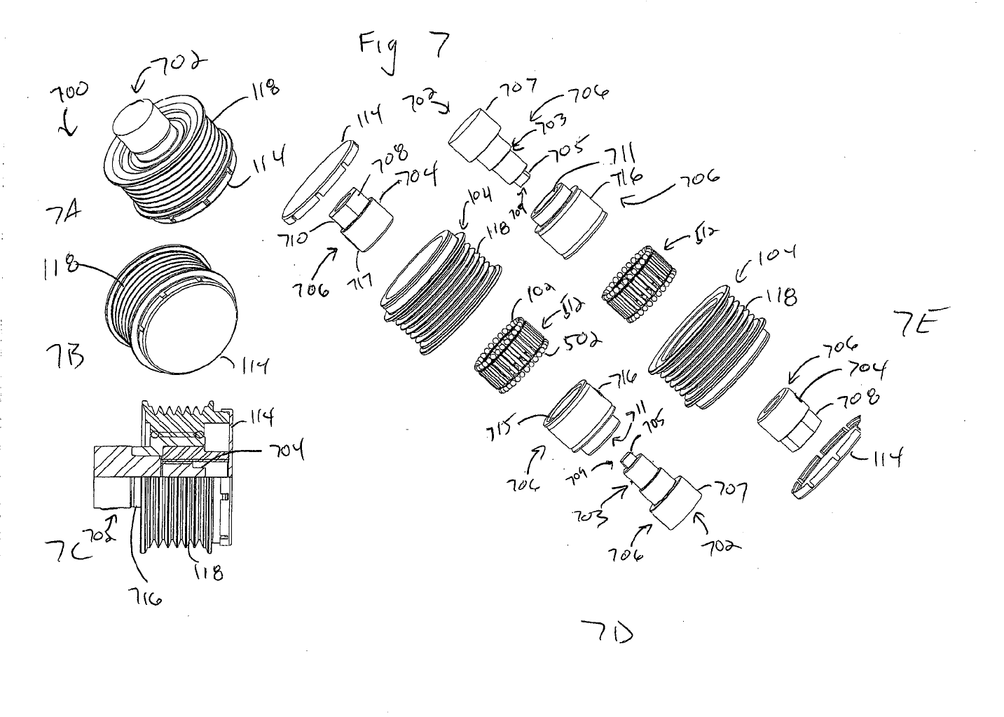

As depicted in FIG. 7, in some embodiments, to accommodate for differing mounting features of various rotor shafts, the overrunning pulley 700 may comprise a multi-piece shaft 706. The multi-piece shaft 706 provides access within the pulley body 104 to allow a tool to be used to couple the multi-piece shaft 706 to the rotor shaft (not shown). In some embodiments, the multi-piece shaft 706 may comprise a body 716, a stem 702 and a key 704. The stem 702 is configured to fit within the opening 711 of the body 716 and is coupled to the key 704. In some embodiments, the body 716 may be configured similar to the shaft described above in FIGS. 5-6. Although described as a multi-piece shaft 706 having separate components (i.e., body 716, stem 702 and key 704), in some embodiments, the multi-piece shaft 706 may be fabricated from a single piece of material providing a one-piece shaft having the same components as described above.

In some embodiments the stem 702 may comprise a base 707 and an outwardly extending portion 703. The outwardly extending portion 703 may comprise a feature 705 on an end 709 opposite the base 707 configured to interface with an internal feature (not shown) of the key 706 to facilitate coupling of the stem 702 to the key 706.

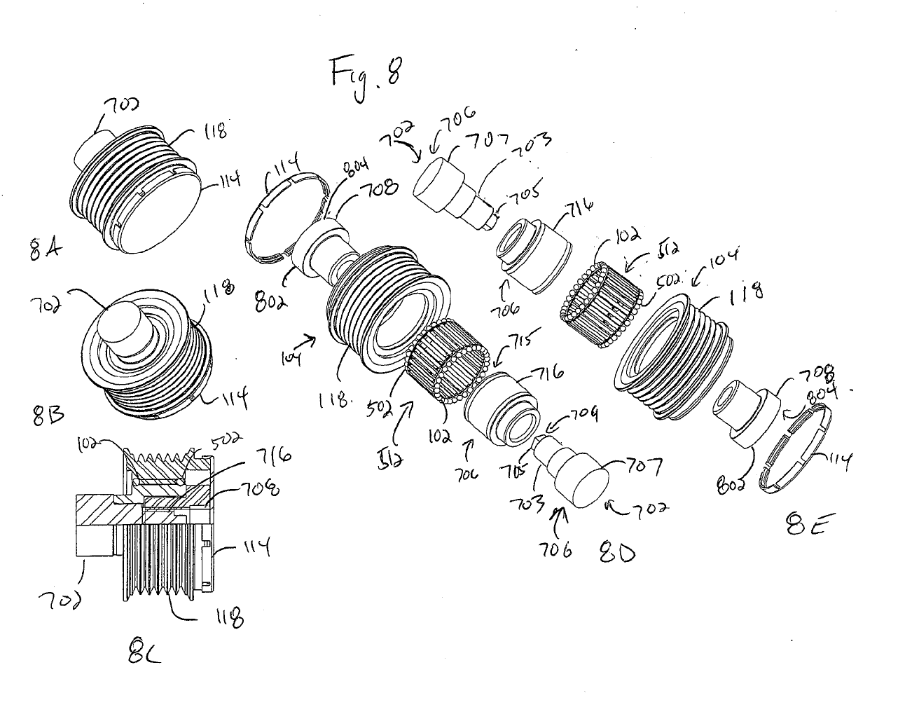

In some embodiments, the key 704 may comprise a first portion 717 configured to fit within the through hole 715 of the body 716 and a second portion 708 configured to interface with a tool to facilitate coupling the multi-piece shaft 706 to a rotor shaft (not shown). In some embodiments, the second portion 708 comprises one or more external features (e.g., hex nut 710) to allow the tool to interface with the key 704. As depicted in FIG. 8, alternatively, in some embodiments, the second portion 708 may comprise an outwardly flanged portion 802 having an internal feature 804 to allow the tool to interface with the key 704.

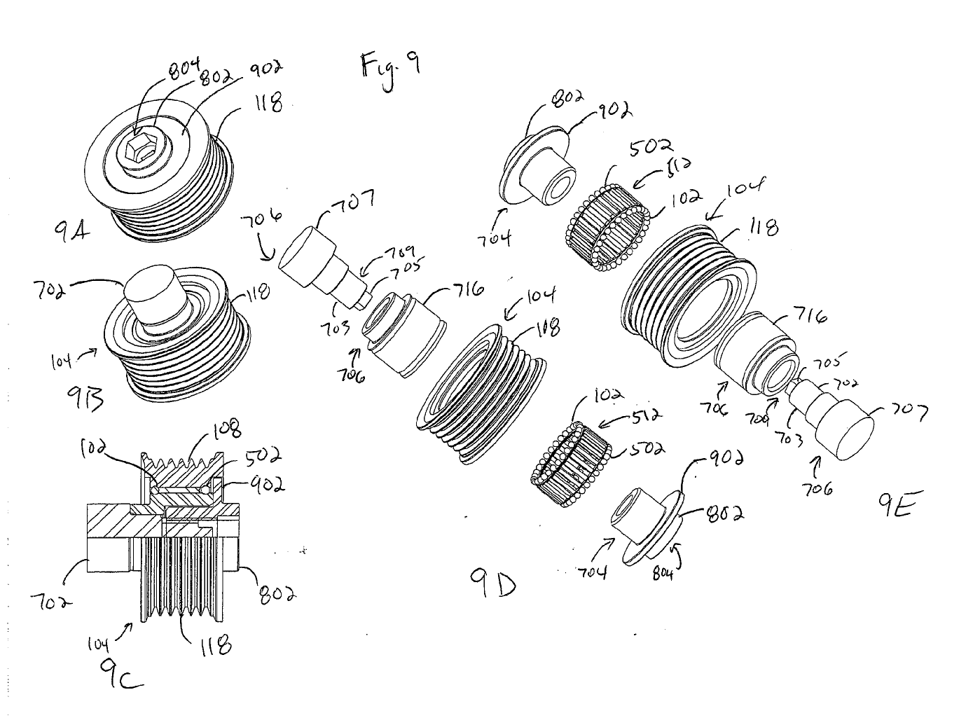

As depicted in FIG. 9, in addition, in some embodiments, the key 704 may further comprise a skirt 902 disposed proximate the outwardly flanged portion 802. In such embodiments, the skirt 902 is configured to fit within the inner diameter 124 of the pulley body 104. When present, the skirt 902 prevents objects and/or substances, such as debris, oil, moisture, or the like from entering the one-way clutch bearing 512.

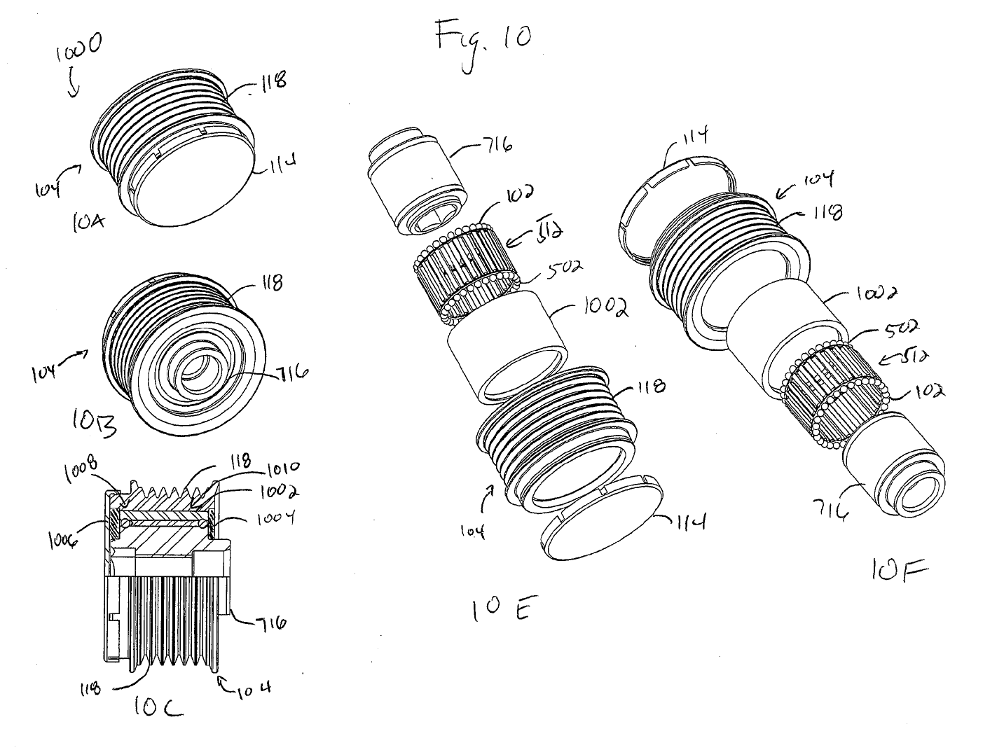

As depicted in FIG. 10, in some embodiments, the overrunning pulley 1000 may comprise a ring 1002 disposed within the pulley body 104 and configured to fit within the inner diameter 124. When present, the ring 1002 may function as the inner race of the one-way clutch bearing 512. In some embodiments, the ring 1002 and pulley body 104 are fabricated as separate components and subsequently coupled together. Alternatively, in some embodiments, the ring 1002 and the pulley body 104 may be fabricated from a single piece of material, thereby providing a single component comprising the pulley body 104 and ring 1002.

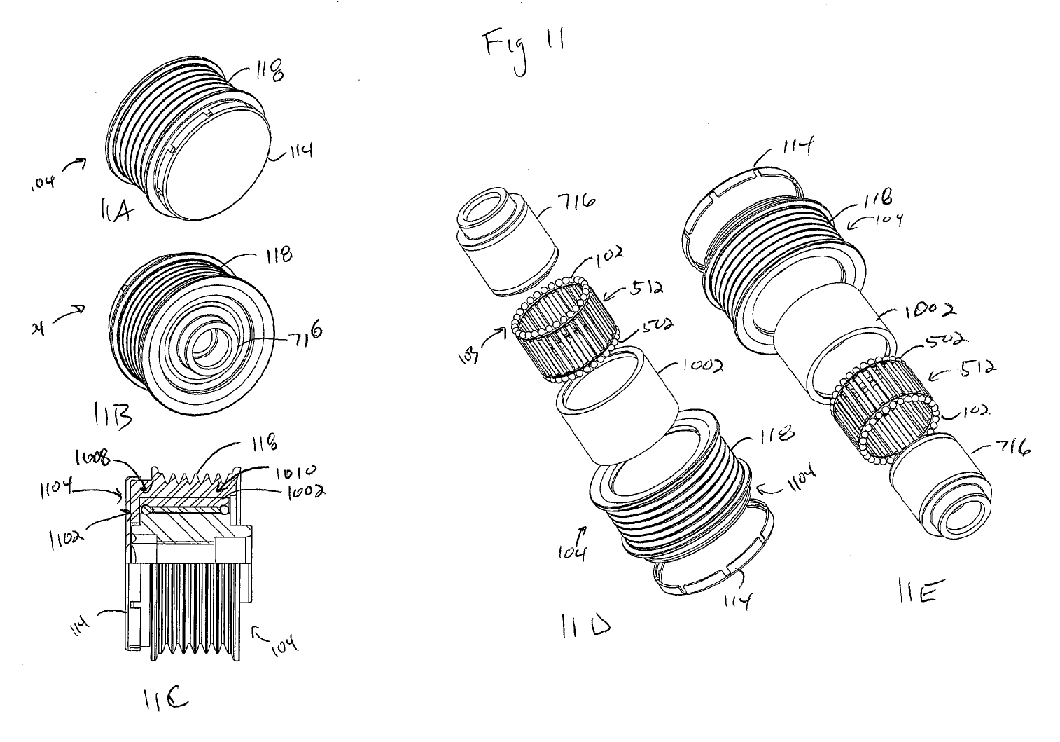

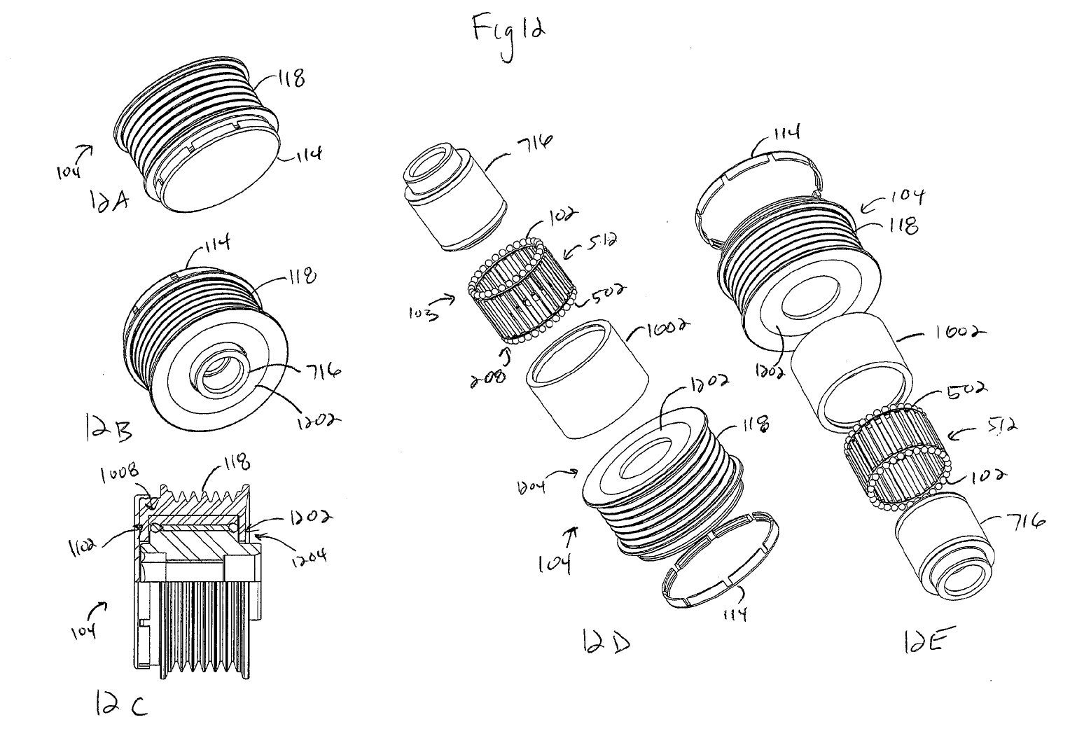

In some embodiments, one or more seals (e.g., o-ring, washer, or the like) 1004, 1006 may be disposed proximate a first end 1008 and/or second end 1010 of the ring 1002 to prevent objects and/or substances, such as debris, oil, moisture, or the like from entering the one-way clutch bearing 112. As depicted in FIG. 11, alternatively, or in combination, in some embodiments, the pulley body 104 may comprise an inwardly extending flange 1102 disposed proximate a first end 1104 of the pulley body 104 and configured to cover the first end 103 of the one-way clutch bearing 512 and journal bearing 102 to prevent the objects and/or substances from entering the one-way clutch bearing 512. As depicted in FIG. 12, in some embodiments, an additional inwardly extending flange 1202 may be disposed proximate a second end 1204 of the pulley body and configured to cover the second end 208 of the one-way clutch bearing 512 and journal bearing 502. In such embodiments, to provide a one piece construction of the pulley body 104, the components (i.e., shaft 716, one-way clutch bearing 512, ring 1002, and journal bearings 102, 502) may first be assembled and the pulley body 104 may be overmolded around the components.

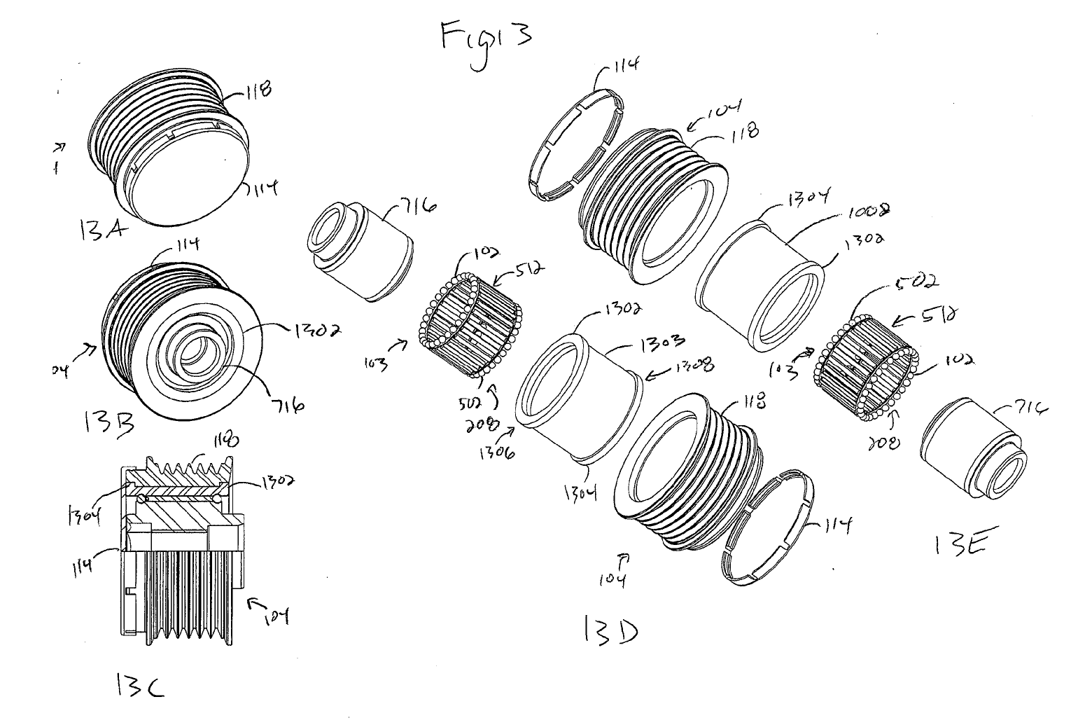

As depicted in FIG. 13, in some embodiments, to secure the ring 1303 in a static position within the pulley body 104, the ring may comprise a first and second outwardly extending flange 1302, 1304 disposed proximate the first and second end of the ring 1306, 1308, respectively. In such embodiments, the pulley body 104 may be overmolded around the ring 1306.

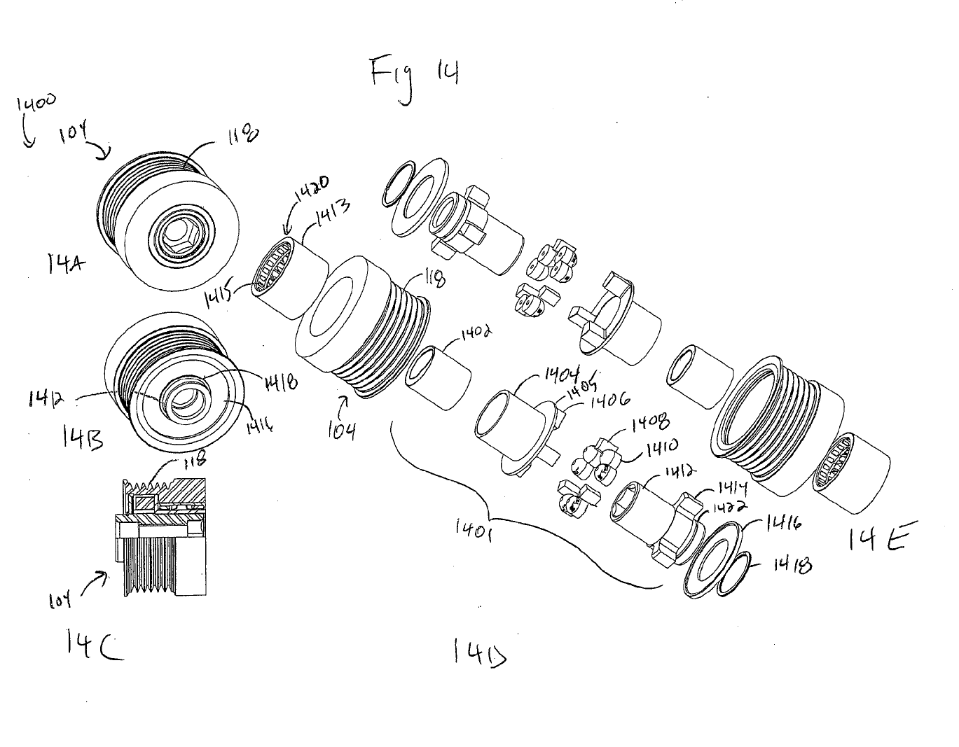

FIG. 14 depicts the overrunning pulley 1400 having a multi-part springy shaft 1401. The multi-part springy shaft 1401 provides springiness in the torque direction, thereby reducing vibration and harshness when engaging or disengaging gears. In some embodiments, the multi-part springy shaft 1401 forms an inner race of a one-way clutch bearing 1415. In such embodiments, a ring 1420 may be disposed around the one-way clutch bearing 1415 to form the outer race 1420. Alternatively, in some embodiments, the pulley body 104 may form the outer race of the one-way clutch bearing 1415, for example, such as discussed above.

The multi-part springy shaft 1401 generally comprises a shaft 1404 having an integrally formed floating/moveable pocket plate 1405 comprising a plurality of over run stops 1406, a plurality of over run stops 1408 and springs 1410, and a stem 1412 having a plurality of outwardly extending paddles 1414. In some embodiments, a bearing 1402 is disposed between the stem 1412 and shaft 1404 to facilitate rotation of the shaft about the stem 1412.

The overrun stops 1406 of the floating/moveable pocket plate 1405 interface with outwardly extending paddles 1414 of the stem 1412 in a torque transfer direction of rotation via one or more springs 1410. The overrun stops 1408 also interface with the outwardly extending paddles 1414 in a counter torque direction of rotation (e.g., overrun) via the overrun stops 1408. In some embodiments, the overrun stops 1406, 1408, springs 1410 and outwardly extending paddles 1414 may be spaced apart from one another at a sufficient distance to allow the stem 1412 and shaft 1404 to rotate about 10 to about 20 degrees with respect to one another.

In some embodiments, a flat washer 1416 is disposed over the stem 1412 to contain the springs 1410 and over run stops 1408. A lock ring 1418 fits within a groove 1422 of the stem 1412 to lock the assembly together and to restrict any relative axial displacement during operation between the components.

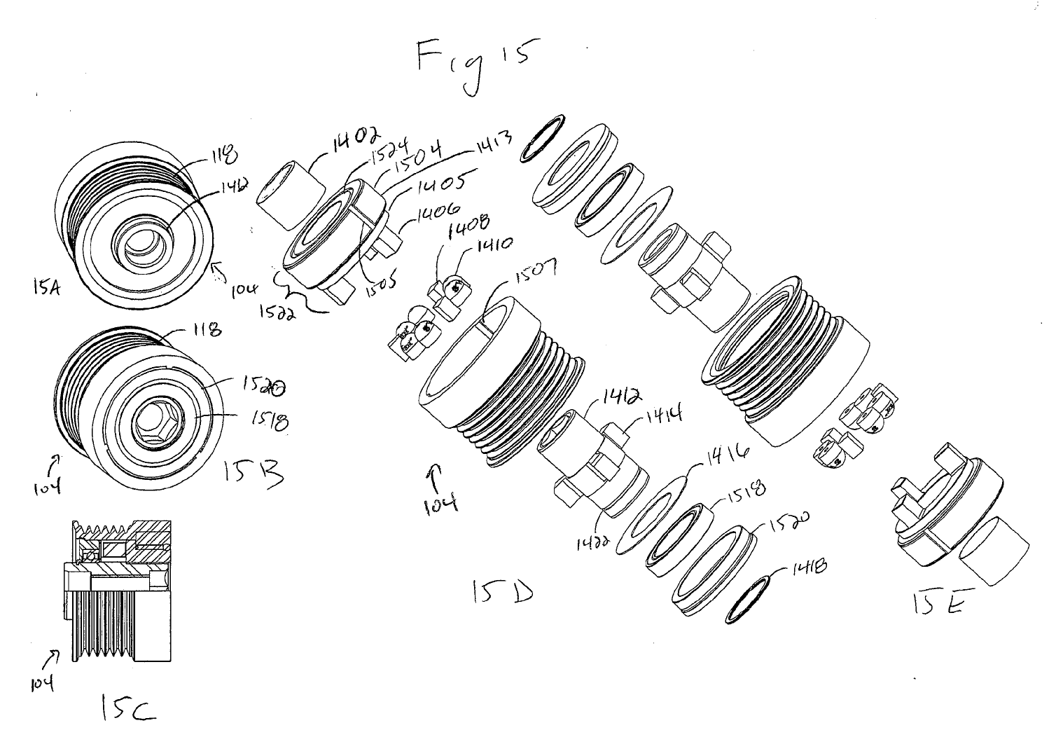

As depicted in FIG. 15, in some embodiments, the floating/moveable pocket plate 1405 may be coupled to an inner race 1524 of the one-way clutch bearing 1413 to form a one-way floating pocket plate 1522. In such embodiments, the pulley body 104 functions as the outer race of the one-way clutch bearing 1413. The one-way floating pocket plate 1522 is rotationally coupled to a pulley body 104. For example, the outer surface 1504 of the one-way floating pocket plate 1522 can be slotted into the pulley body 104, or can be pressed fit, adhesive glued, or overmolded into the pulley body 104. For example, as shown in FIG. 15, one or more notches (one notch 1505 shown) may be formed in the outer surface of the one-way floating pocket plate 1522 and configured to interface with a slot 1507 of the pulley body 104. In some embodiments, a two-way bearing 1518, contained in a housing 1520, may be disposed proximate an end of the stem 1412, opposite the one-way floating pocket plate 1522, to facilitate smooth rotation of the pulley body 104.

Thus, apparatus for coupling torque have been provided herein. The inventive apparatus advantageously provides an active pulley design requiring fewer components, thus making it more durable, easier and less expensive to manufacture, and lower in weight, as compared to conventional active pulley designs.

While the foregoing is directed to various embodiments of the present invention, other and further embodiments of the invention may be devised without departing from the basic scope thereof.

1. An apparatus for coupling torque, comprising:
a shaft;
a pulley body disposed about the shaft, the pulley body and shaft rotatable with respect to each other;
a one-way clutch bearing disposed between the pulley body and shaft; and
a journal bearing disposed proximate a first end of the one-way clutch bearing, wherein at least one of the pulley body and the shaft form a race of at least one of the one-way clutch bearing or journal bearing.

2. The apparatus of claim 1, further comprising an inner race disposed within the one-way clutch bearing, wherein the pulley body forms an outer race of the one-way clutch bearing.

3. The apparatus of claim 1, wherein the shaft forms an inner race of the one-way clutch bearing and the pulley body forms an outer race of the one-way clutch bearing.

4. The apparatus of claim 1, further comprising an end cap disposed on an open end of the pulley body.

5. The apparatus of claim 1, wherein an outer surface of the pulley body is configured to interface with a drive mechanism.

6. The apparatus of claim 1, further comprising a bearing disposed proximate a second end of the one-way clutch bearing, opposite the first end.

7. The apparatus of claim 6, wherein the bearing is one of a second journal bearing or a roller bearing.

8. The apparatus of claim 1, further comprising a bushing disposed proximate a second end of the one-way clutch bearing, opposite the first end, wherein the shaft comprises a flange configured to interface with the bushing.

9. The apparatus of claim 1, wherein the shaft comprises:
a body having a through hole;
a stem having an outwardly extending portion configured to fit within the through hole; and
a key coupled to the outwardly extending portion of the stem, the key having at least one feature for coupling the key to a tool.

10. The apparatus of claim 9, wherein the at least one feature is one of a threaded portion or bolt head.

11. The apparatus of claim 1, further comprising a ring disposed within the pulley body, wherein the ring forms the outer race of the one-way clutch bearing.

12. The apparatus of claim 11, wherein the pulley body is overmolded about the ring.

13. The apparatus of claim 11, wherein the ring is coupled to the pulley body via press fitting or an adhesive.

14. The apparatus of claim 11, wherein the ring comprises an outwardly extending flange disposed proximate at least one of a first end or a second end of the ring, wherein the outwardly extending flange is configured to interlock with at least one inwardly extending flange of the pulley body.

15. The apparatus of claim 11, wherein the ring is integrally formed within the pulley body.

16. The apparatus of claim of claim 1, wherein the shaft comprises:
a floating pocket plate coupled to a hollow shaft, the floating pocket plate comprising a plurality of downwardly facing over run stops;
a stem having a plurality of outwardly extending paddles coupled to a lower portion of the stem, wherein an upper portion of the stem is disposed within the hollow shaft;
a bearing disposed between the hollow shaft and the upper portion of the stem to facilitate rotation of the hollow shaft and stem with respect to each other, wherein the plurality of downwardly facing over run stops of the floating pocket plate interface with the outwardly extending paddles of the stem in a torque transfer direction of rotation via one or more springs disposed between the plurality of downwardly facing over run stops and the outwardly extending paddles, and wherein the overrun stops also interface with the outwardly extending paddles in a counter torque direction of rotation via a plurality of over run stops disposed between the plurality of downwardly facing over run stops and the outwardly extending paddles.

17. The apparatus of claim 16, wherein the floating pocket plate is coupled to an inner race of the one-way clutch bearing, and rotatably coupled to the pulley body.

18. The apparatus of 17, further comprising a two-way bearing disposed proximate the lower portion of the stem.

19. The apparatus of claim 1, wherein the shaft comprises a through hole configured to interface with an outwardly extending portion of a rotor shaft.
